(19) United States
(12) Patent Application Publication
(10) Pub. No.: US 2021/0198534 A1
(43) Pub. Date: Jul. 1, 2021

(54) PRESSURE-SENSITIVE ADHESIVE WITH FILLER

(71) Applicant: 3M INNOVATIVE PROPERTIES COMPANY, St. Paul, MN (US)

(72) Inventor: Dean M. Moren, North St. Paul, MN (US)

(73) Assignee: 3M Innovative Properties Company

(21) Appl. No.: 17/200,263

(22) Filed: Mar. 12, 2021

Related U.S. Application Data
(63) Continuation of application No. 16/070,297, filed on Jul. 16, 2018.
(60) Provisional application No. 62/279,993, filed on Jan. 18, 2016.

(51) Int. Cl. C09J 7/38; C09J 11/04; C09J 133/04; C08F 2/44

(52) U.S. Cl. CPC C09J 7/385; C09J 11/04; C08K 7/28; C08F 2/44; C09J 133/04

(57) ABSTRACT

Provided are curable precursor compositions for pressure-sensitive adhesives and related articles, assemblies and methods. The provided compositions contain an alkyl (meth)acrylate, a hollow non-porous particulate filler, and a surface-modifying agent comprising a hydrophobic alkoxy silane or hydrophobic organofunctional polysiloxane. These compositions and methods enable in situ functionalization of the filler particles during or after the time they are combined with the curable resin components, thereby allowing pressure-sensitive adhesive materials to be made faster and more efficiently than when using conventional manufacturing methods.

### FIELD OF THE INVENTION

Provided are compositions, articles, assemblies, and methods related to pressure-sensitive adhesives.

### BACKGROUND

Pressure-sensitive adhesives (PSAs) are viscoelastic materials that can be conveniently used to bond substrates to each other. PSAs have broad applicability in diverse commercial and industrial areas. A typical application is in tape products, commonly used for holding, marking, protecting, sealing, and masking purposes.

Useful PSAs are known to possess certain properties, including aggressive and permanent tack, adherence with no more than finger pressure, and sufficient interfacial bond strength and cohesive bond strength to a given adherend. Materials that perform well as a PSA tend to be polymers engineered to display the requisite viscoelastic properties such that there is an appropriate balance of tack, peel adhesion, and shear strength. It is common for such materials to be made from, for example, (meth)acrylate-based polymer and copolymers, natural rubber, synthetic rubbers, and silicones.

For both performance, cost and weight considerations, it can be highly desirable to incorporate certain particulate additives (or fillers) into a PSA composition. Inorganic fillers, such as fumed silica particles, can improve the physical properties of a PSA tape. As described previously in PCT Publication No. WO 2014/186316 (Heimink et al.), other filler materials such as hollow glass microspheres or other hollow non-porous fillers can also provide structural reinforcement, reduce weight and cost, and also enhance peel strength and shear strength, particularly when the hollow glass microspheres are modified to include a hydrophobic surface. With the cost of the hollow non-porous fillers being less than that of the polymeric resins of the PSA, the manufacturing costs of the tape can be reduced. The same is true with respect to the weight unit of the tape, which can also be reduced based on the specific density of the hollow non-porous fillers being less than that of the hardened (or cured) polymeric resins.

### SUMMARY

One technical challenge in working with hollow non-porous fillers relates to their extremely small grit size. Because these fillers are so tiny, they can easily become airborne and render the problem of modifying, manipulating and containing such materials messy and difficult. A second problem is the complex equipment required to deliver the surface treatment to the filler particles, which demands significant time, capital and other resources. Additional processing steps are also commonly used to functionalize, clean, rinse, and dry the fillers, which can entail additional energy consumption and use of solvents.

Described herein are compositions and methods that eliminate or alleviate the technical issues above by providing for in situ functionalization of the filler particles during or after the time they are combined with the curable resin components. This can be achieved by using a composition with a hydrophobic alkoxy silane or hydrophobic organofunctional polysiloxane as a surface-modifying agent. These compositions and methods allow PSAs that derive from surface-modified fillers to be made faster and more efficiently than when using conventional manufacturing methods.

In a first aspect, a curable precursor composition is provided. The curable precursor composition comprises: an alkyl (meth)acrylate; a hollow non-porous particulate filler; and a surface-modifying agent comprising a hydrophobic alkoxy silane or hydrophobic organofunctional polysiloxane.

In a second aspect, a pressure-sensitive adhesive composition is provided by curing the aforementioned curable precursor composition.

In a third aspect, a pressure-sensitive adhesive assembly is provided comprising a backing layer; and a first pressure-sensitive adhesive layer comprising the aforementioned pressure-sensitive adhesive composition disposed on the backing layer.

In a fourth aspect, a method of making a pressure-sensitive adhesive is provided, comprising: mixing an alkyl (meth)acrylate, hollow non-porous particulate filler, and a surface-modifying agent comprising a hydrophobic alkoxy silane or hydrophobic organofunctional polysiloxane to provide a curable precursor composition; and curing the curable precursor composition to provide the pressure-sensitive adhesive.

### DETAILED DESCRIPTION

The PSAs of the present disclosure are prepared from a hollow non-porous particulate filler, the surface of which predominantly comprises silica. These silica surfaces undergo treatment with hydrophobic alkoxy silane and/or hydrophobic organofunctional polysiloxane, which react with the silica to provide a hydrophobic surface modification. In this process, surface modification takes place either during or after the process of mixing together the filler and the curable resin components of the curable precursor composition, but not before.

Such pressure-sensitive adhesives can combine high peel strength and high shear force resistance on various types of substrates. These advantages can be obtained on substrates including low surface energy (LSE), medium surface energy (MSE) and/or high surface energy (HSE) substrates. This is particularly surprising finding as LSE, MSE and HSE substrates typically exhibit completely different surface chemistry and energy.

“Low surface energy substrates” refers to substrates having a surface energy of less than 34 dynes per cm. Included among such materials are polypropylene, polyethylene (e.g., high density polyethylene or HDPE), and blends of polypropylene (e.g. polypropylene/ethylene propylene diene monomer (PP/EPDM), thermoplastic polyolefin (TPO)).

“Medium surface energy substrates” refers to substrates having a surface energy comprised between 34 and 70 dynes per cm, typically between 34 and 60 dynes per cm, and more typically between 34 and 50 dynes per cm. Included among such materials are polyamide 6 (PA6), acrylonitrile butadiene styrene (ABS), polycarbonate (PC)/ABS blends, PC, polyvinylchloride (PVC), polyamide (PA), polyurethane (PUR), thermoplastic elastomer (TPE), polyoxymethylene (POM), polystyrene, poly(methyl methacrylate), clear coat surfaces, in particular clear coats for vehicles like a car, and coated surfaces for industrial applications and composite materials such as fiber reinforced plastics.

“High surface energy substrates” refers to substrates having a surface energy of more than 350 dynes per cm, typically more than 400 dynes per cm, and more typically to those substrates having a surface energy comprised between 400 and 1100 dynes per cm. Included among such materials are metal substrates (e.g. aluminum, stainless steel), and glass.

The surface energy is typically determined from contact angle measurements as described, for example, in ASTM D7490-08.

“Hydrophobic surface modification” indicates that the surface of the hollow non-porous particulate filler, after suitable surface modification, has significantly reduced affinity for polar substances, particularly water.

Multilayer PSA assemblies based on the present disclosure can, in exemplary applications, be adhered to automotive body side moldings, weather strips, road signs, commercial signs, constructions, electrical cabinets, shell moulds, machine parts, junction boxes or backsheet solutions for photovoltaic modules. The multilayer PSA assembly is particularly suited for bonding to low energy surfaces, such as polyolefin surfaces and clear coat surfaces. The multilayer PSA assembly disclosed herein may be advantageously bonded to automotive clear coat surfaces.

In some embodiments, the PSA layer or layers include a hollow non-porous particulate filler whose surfaces are provided with a hydrophobic surface modification through a surface-modifying agent such as a hydrophobic alkoxy silane, hydrophobic organofunctional polysiloxane, or mixture thereof.

The use of a hollow non-porous particulate filler in the at least first PSA layer of the PSA assembly allows producing a cost-effective PSA assembly by reducing the overall weight/density of the PSA assembly and by reducing the consumption of the precursor composition used to form the at least first PSA layer of the PSA assembly.

In an advantageous embodiment, the hollow, non-porous particulate material significantly impedes the ability of the resin components of the precursor composition to fill the interstitial spaces created by the particulate filler material in the at least first PSA layer, for example, by capillary action, adsorption or absorption.

Particular aspects of the aforementioned PSAs and PSA assemblies—constructions, hollow fillers, monomers, tackifiers, plasticizers, crosslinkers, initiators, chain transfer agents, other optional additives, polymerization methods, manufacturing methods, and applications—shall now be more specifically described under respective subheadings below.

### Constructions

PSAs and PSA assemblies according to the present disclosure may have any of a number of suitable configurations based on the intended application and desired properties.

A PSA, for example, may take the form of a single layer construction, and consist essentially of a first PSA layer. Such a single layer assembly can be advantageously used, for example, as a transfer tape—i.e., a double-sided adhesive tape without a backing.

In an alternative aspect, the PSA assembly of the present disclosure may take the form of a multilayer construction, and include two or more superimposed layers—e.g., the first PSA layer and adjacent layers such as a backing layer and/or further PSA layers. Adhesive multilayer constructions or tapes may be advantageously used as a dual-layer adhesive tape to adhere two objects to one another. Backing layers for use herein may or may not exhibit at least partial PSA characteristics.

Where a backing layer is present, a common PSA assembly is a three-layer configuration in which the backing layer is sandwiched between two discrete PSA layers.

Regarding multilayer PSA assemblies, the present disclosure is not limited to the embodiments above. As an alternative, the PSA assembly may comprise at least one intermediate layer between a backing layer and PSA layer(s). These intermediate layers, as well as the backing layer, may exhibit advantageous mechanical properties, such as e.g. increasing the tear resistance of the multilayer PSA assembly or optical functionalities such as, for example, light transmission, reflection, color, and labeling.

In a particular aspect, the intermediate layer comprises a polymer selected from the group consisting of polyacrylates, polyurethanes, polyolefins, polystyrene, polyamides, natural rubbers, synthetic rubbers, and polyvinylpyrrolidone, along with copolymers and mixtures thereof.

It is also possible, however, that the intermediate PSA layer(s) is made from a curable precursor composition as described in this disclosure. The formulation of the intermediate layer(s) may be identical or different compared to the PSA layer.

Useful backing layers can be made from plastics (e.g., polypropylene, including biaxially oriented polypropylene, vinyl, polyethylene, polyester such as polyethylene terephthalate), nonwovens (e.g., papers, cloths, nonwoven scrims), metal foils, foams (e.g., polyacrylic, polyethylene, polyurethane, neoprene), and the like.

In a particular embodiment, the PSA assembly of the present disclosure is in the form of a multilayer PSA assembly further comprising a second PSA layer adjacent to the first PSA layer.

Where the multilayer PSA assembly further comprises a second PSA layer adjacent to the first PSA layer, the multilayer PSA assembly of the present disclosure may advantageously take the form of skin/core type multilayer PSA assembly, wherein the first PSA layer is the core layer of the multilayer

PSA assembly and the second PSA layer is the skin layer of the multilayer PSA assembly. The skin layer can extend across and directly contact both major surfaces of the core layer. Such kinds of multilayer PSA assemblies are well known.

In some embodiments, the PSA assembly comprises a first PSA layer that is a polymeric foam. The term “polymeric foam” refers to a polymeric material that comprises voids, typically in an amount of at least 5% by volume, from 10% to 55% by volume, or from 10% to 45% by volume.

The voids or cells in the polymeric foam layer can be created by any known method. Such methods include the use of a gas or other physical blowing agent and/or including hollow non-porous particles into the composition for the polymeric foam layer. For example, according to one method to create a polymeric foam described in US 4,415,615, an acrylic foam can be obtained by the steps of (i) frothing a composition containing the acrylate monomers and optional co-monomers, (ii) coating the froth on a backing and (iii) polymerizing the frothed composition. It is possible to coat the unfrothed composition of the acrylate monomers and optional co-monomers to the backing and to then simultaneously foam and polymerize that composition. Frothing of the composition may be accomplished by whipping a gas into the polymerizable composition. Preferred gasses for this purpose are inert gasses such as nitrogen and carbon dioxide.

A polymeric foam layer for use herein has for example a thickness of between 100 □m and 6000 58 m, between 200 □m and 4000 □m, between 500 □m and 2000 □m, or between 800 □m and 1500 □m.

The polymeric foam layer can have a density of between 0.45 g/cm³ and 1.5 g/cm³, between 0.45 g/cm³ and 1.10 g/cm³, between 0.50 g/cm³ and 0.95 g/cm³, between 0.60 g/cm³ and 0.95 g/cm³, or between 0.70 g/cm³ and 0.95 g/cm³. This density is achieved by incorporating voids or cells into the polymeric matrix of the foam. Typically, the polymeric foam layer will comprise at least 5% of voids by volume and for example between 15 and 45%, or between 20% and 45% by volume.

A skin/core type multilayer PSA assembly, wherein the first PSA layer is the core layer of the multilayer PSA assembly and the second PSA layer is the skin layer of the multilayer PSA assembly, may advantageously comprise a core layer (i.e. the first PSA layer) that is a polymeric foam layer. This configuration is sometimes referred to as a dual layer polymeric foam tape assembly.

Multilayer PSA assemblies according to the present disclosure, and in particular dual layer polymeric foam tape assemblies, can be advantageous compared with single-layer PSAs, because adhesion properties can be adjusted based on the formulation of the second PSA layer (commonly referred to as the skin layer), while other properties/requirements of the overall assembly such as application issues, deforming issues and energy distribution can be addressed by the formulation of the polymeric foam layer (commonly referred to as the core layer). In some embodiments, the multilayer PSA assemblies as disclosed herein are smooth, homogenous and consist of layers which are chemically bonded to each other.

In some instances, it may be advantageous for the multilayer PSA assemblies of the present disclosure to further comprise a third PSA layer which is adjacent to the first PSA layer in the side of the first PSA layer which is opposed to the side of the first PSA layer adjacent to the second PSA layer, and thereby forming a three-layered multilayer PSA assembly.

As a further option, a three-layered multilayer PSA assembly can take the form of a skin/core/skin multilayer PSA assembly, wherein the first PSA layer is the core layer of the multilayer PSA assembly, the second PSA layer is the first skin layer of the multilayer PSA assembly and the third PSA layer is the second skin layer of the multilayer PSA assembly.

The thickness of the various PSA layer(s) and other optional layer(s) comprised in the PSA assembly may vary in wide ranges depending on the desired execution and associated properties. By way of example, the thickness can be independently chosen for each layer between 25μm and 6000μm, between 40μm and 3000μm, between 50μm and 3000μm, between 75μm and 2000 μm, or between 75μm and 1500μm. Unless specified otherwise, it is to be understood that all ranges in the present disclosure are intended to be inclusive of their endpoints.

According to the particular execution, wherein the multilayer PSA assembly takes the form of skin/core type multilayer PSA assembly, wherein the first PSA layer is the core layer of the multilayer PSA assembly and the second PSA layer is the skin layer of the multilayer PSA assembly, it is preferred that the second PSA layer has a lower thickness compared to the first PSA layer. This is particularly advantageous in executions where the first PSA layer is a polymeric foam layer, thereby forming a polymeric foam PSA tape. As a way of example, the thickness of the second PSA layer may typically be in the range of from 20μm to 250μm, or from 40μm to 200μm, whereas the thickness of the polymeric foam layer may typically be in the range of from 100μm to 6000μm, from 400μm to 3000μm, or from 800μm to 2000μm. Such multilayer PSA assemblies can exhibit high peel adhesion. In some instances, improved peel adhesion can be caused by a stabilizing effect of the relatively thick polymeric foam layer compared to the first PSA layer.

To facilitate handling and storage, a provided PSA assembly can be optionally provided on at least one of its major surfaces with a release liner. Any suitable material known to the skilled person can be used as a release liner, such as siliconized paper or siliconized polymeric film material, in particular a siliconized PET-film or a siliconized PE or PE/PP blend film material.

### Hollow Fillers

The provided PSA materials include hollow non-porous particulate fillers. Exemplary hollow non-porous particulate fillers for use herein include, but are not limited to, those selected from the group consisting of hollow glass microspheres, hollow inorganic beads, hollow inorganic particles, hollow silica particles, hollow carbide particles (e.g. silicon carbide particles, boron carbide particles), hollow nitride particles (e.g. carbon nitride particles, aluminum nitride particles, silicon nitride particles, boron nitride particles), hollow polymeric particles, and mixtures thereof.

Preferred hollow non-porous particulate fillers are made from an inorganic material. Even more preferably, the hollow non-porous particulate filler is a closed-cell type particulate inorganic material.

In a particular aspect, the hollow non-porous particulate filler is selected from the group consisting of hollow glass microspheres, hollow ceramic particles, hollow glass balloons, hollow inorganic beads, and mixtures thereof.

In a preferred aspect, the hollow non-porous particulate filler for use herein consists of hollow glass microspheres.

Suitable hollow non-porous particulate fillers are commercially available from various filler material suppliers. Hollow glass microspheres for use herein are for example those commercially available from 3M Company, St. Paul, Minn., under commercial name 3M Glass Bubbles.

Suitable hollow non-porous particulate fillers for use herein may have various particle sizes, particle shapes, particle size distributions, particle aspect ratios, and are not particularly limited. The selection of such parameters depends on the particular properties required for the first PSA layer and/or the PSA assembly.

Suitable hollow non-porous particulate fillers can have an average particle size of at least 1 □m, at least 10 □m, at least 30 □m, or at least 50 □m. In some embodiments, the average particle size can be up to 500 □m, up to 300 □m, up to 200 □m, up to 150 □m, or up to 100 58 m.

The hollow non-porous particulate filler for can have a substantially spherical shape. Average particle size as described above would correspond to the number average diameter of the hollow non-porous filler particles.

In exemplary embodiments, the provided PSA contains at least 5 weight percent, at least 6 weight percent, at least 7 weight percent, at least 8 weight percent, at least 9 weight percent, or at least 10 weight percent hollow, non-porous particulate filler, relative to the overall weight of the PSA layer. In exemplary embodiments, the provided PSA contains up to 20 weight percent, up to 17 weight percent, up to 15 weight percent, up to 14 weight percent, up to 13 weight percent, or up to 12 weight percent hollow, non-porous particulate filler, relative to the overall weight of the PSA layer.

It is believed that use of hollow non-porous particulate filler provided with in situ hydrophobic surface modification can provide PSA assemblies with beneficial (micro)mechanical properties, which correlate with improved peel performance on various substrates. The hydrophobic surface modification of the hollow non-porous particulate filler can strongly influence the interaction between the filler particle and the surrounding resin matrix of the first PSA layer, and in particular a polymeric precursor composition.

Use of a hollow non-porous particulate filler provided with a hydrophobic surface modification can enable delamination between the resin component matrix and the surface of the filler particles. These weaker interactions between the hardened resin matrix and the filler particles, and therefore improved deformability of the resulting PSA assembly, are believed to result in a better stress distribution/dissipation through the PSA assembly which in turn provides improved the peel performance on various substrate types.

The hydrophobic surface modification can be obtained by chemical treatment, and in particular by the in situ chemical surface functionalization provided by curable precursor compositions comprising an alkyl (meth)acrylate, a hollow non-porous particulate filler, and a surface-modifying agent comprising a hydrophobic alkoxy silane or hydrophobic organofunctional polysiloxane.

Hydrophobic surface modification of the hollow non-porous particulate filler can be performed with non-polar groups, alkyl groups through covalent bonds, and through covalent siloxane bonds, between the non-polar groups (preferably, alkyl groups) and the surface of the hollow non-porous particulate filler.

In the provided PSAs, the surface of the hollow non-porous particulate filler is rendered hydrophobic by chemically reacting the hollow non-porous particulate filler with a surface-modifying agent.

More preferably, the surface of the hollow non-porous particulate filler is rendered hydrophobic by chemically reacting the hollow non-porous particulate filler with a hydrophobic silane, hydrophobic organofunctional polysiloxane, or combination or mixture thereof. Useful hydrophobic silanes include alkoxy silanes.

Especially useful alkoxy silanes and organofunctional polysiloxanes have the following chemical structure:

(R¹-O)ₘ(R²)ₚSi—[(O—Si(OR¹)_{q}(R²)_{2-361 q})ₓ—Si(P—R¹)ₘ(R²)₃₋ₘ]ᵣ

, where R¹ is independently an alkyl, R² is independently a hydrophobic moiety selected from the group consisting of: saturated, unsaturated, linear, branched, and cyclic alkyls, and combinations thereof, m is in a range of from 0 to 3, p is in a range of from 0 to 3, q is in a range of from 0 to 2, r is in a range of from 0 to 4, x is in a range of from 0 to 9, and where the sum m+p+r equals 4 and at least one R¹ and at least one R² are present.

As used above, the term “independently” denotes that each designation of R¹ or R² represents a chemical group that may or may not be the same as another represented by a like designation elsewhere in the chemical structure.

Optionally, R¹ is has 1 to 6 carbon atoms or, more preferably, 1 to 4 carbon atoms. R¹ can be independently selected from the group consisting of methyl, ethyl, propyl and butyl, and more preferably from the group consisting of methyl and ethyl.

Optionally, m is in a range of from 1 to 3, m is 2 or 3, or m is 3.

Optionally, R² can have from 1 to 100 carbon atoms, from 1 to 50 carbon atoms, from 1 to 30 carbon atoms, or from 1 to 25 carbon atoms. In some embodiments, R² is selected from the group consisting of methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, and fluorinated derivatives thereof, tridecafluroro-1,2,2,2-tetrahydrooctyl; yet more preferably R² is independently selected from the group consisting of methyl, propyl, n-octyl, and hexadecyl.

In the chemical structure above, it is noted that r is 0 for alkoxy silanes and r is in a range from 1 to 4 for organofunctional polysiloxanes.

Alkoxy silanes and organofunctional polysiloxanes generate alcohol upon reaction with, for example, water or siliceous materials. When R² is ethyl, alkoxy silanes and organofunctional polysiloxanes liberate the alcohol ethanol. As ethanol is relatively benign from an environmental, health and safety perspective, R² is preferably an ethyl group.

Use of an organofunctional polysiloxane can provide additional advantages. For example, the volatility of alkoxy silanes and organofunctional polysiloxanes generally decreases with increasing molecular weight. Volatile organic compounds can be a nuisance to work with in a manufacturing setting, since they may need to be isolated or otherwise recaptured. Organofunctional polysiloxanes, which are oligomeric, liberate volatile organic compounds to a substantially lesser extent compared with their parent alkoxy silanes. Therefore, r is preferably in a range from 1 to 4.

Advantageously, the hydrophobic surface modification of the hollow non-porous particulate filler can be performed at the time the filler is compounded with the curable precursor composition. As explained earlier, this represents a significant technical advantage in the manufacturing process because in situ surface modification can obviate process steps required when modifying the filler particles prior to compounding. Such process steps can include, for example, cleaning, rinsing, and drying of the surface-treated filler particles, in addition to the silanization step itself. Eliminating these steps can significantly improve manufacturing efficiency while reducing solvent consumption and waste.

The surface-modifying agent can be provided in a liquid medium, or preferably as neat alkoxy silane, organofunctional polysiloxanes, or combination or mixture thereof. The surface-modifying agent can be present in an amount sufficient to provide hydrophobic surface modification of the hollow non-porous particulate filler and can be at least 0.1 percent, at least 0.2 percent, at least 0.4 percent, at least 0.6 percent, or at least 0.8 percent, based on the overall weight of the curable precursor composition. In some embodiments, the surface-modifying agent can be present in an amount of up to 4 percent, up to 3 percent, up to 2 percent, up to 1.5 percent, or up to 1.2 percent, based on the overall weight of the curable precursor composition.

### PSA Monomers

In a particular aspect, the first PSA layer and/or the second PSA layer and/or the third PSA layer includes a polymer base material selected from the group consisting of polyacrylates, polymethacrylates, polyurethanes, polyolefins, polyamines, polyamides, polyesters, polyethers, polyisobutylene, polystyrenes, polyvinyls, polyvinylpyrrolidone, natural rubbers, and synthetic rubbers, along with copolymers and blends thereof.

Preferably, the provided PSAs contain a polymer base material selected from the group consisting of polyacrylates, polymethacrylates and polyurethanes, along with copolymers and blends thereof. More preferably, the first PSA layer and/or the second PSA layer and/or the third PSA layer comprise a polyacrylate.

Preferred poly(meth)acrylates can be polymerized from a monomer component comprised of a linear or branched alkyl (meth)acrylate ester, preferably a non-polar linear or branched alkyl (meth)acrylate ester having a linear or branched alkyl group comprising preferably from 1 to 32 carbon atoms, from 1 to 20 carbon atoms, or from 1 to 15 carbon atoms.

Here, the term “alkyl (meth)acrylate” and “alkyl (meth)acrylate ester” are used interchangeably. The term “(meth)acrylate” refers to an acrylate, methacrylate, or both. The term “(meth)acrylic” refers to methacrylic, acrylic, or both. A “(meth)acrylic-based” material refers to one prepared from one or more monomers having a (meth)acryloyl group, which is a group of formula CH₂═C(R)—(CO)—, where R is hydrogen or methyl.

The term “alkyl” refers to a monovalent group which is a saturated hydrocarbon. The alkyl can be linear, branched, cyclic, or combinations thereof and typically has 1 to 32 carbon atoms. A given alkyl group can contain 1 to 25 carbon atoms, 1 to 20 carbon atoms, 1 to 18 carbon atoms, 1 to 12 carbon atoms, 1 to 10 carbon atoms, 1 to 8 carbon atoms, 1 to 6 carbon atoms, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, 2-ethylhexyl, 2-octyl and 2-propylheptyl.

The terms “glass transition temperature” and “T_{g}” are used interchangeably and refer to the glass transition temperature of a material or a mixture. Unless otherwise indicated, glass transition temperature values are determined by Differential Scanning Calorimetry.

Useful alkyl (meth)acrylates include methyl (meth)acrylate, ethyl (meth)acrylate, n-propyl (meth)acrylate, isopropyl (meth)acrylate, n-butyl acrylate, isobutyl acrylate, tert-butyl (meth)acrylate, n-pentyl (meth)acrylate, iso-pentyl (meth)acrylate, n-hexyl (meth)acrylate, iso-hexyl (meth)acrylate, cyclohexyl (meth)acrylate, phenyl (meth)acrylate, octyl (meth)acrylate, isooctyl (meth)acrylate, 2-octyl(meth)acrylate, 2-ethylhexyl (meth)acrylate, decyl (meth)acrylate, lauryl (meth)acrylate, 2-propylheptyl (meth)acrylate, stearyl (meth)acrylate, isobornyl acrylate, benzyl (meth)acrylate, octadecyl acrylate, nonyl acrylate, dodecyl acrylate, and isophoryl (meth)acrylate, along with combinations or blends thereof.

Preferred linear or branched alkyl (meth)acrylate esters include isooctyl (meth)acrylate, 2-ethylhexyl (meth)acrylate, 2-propylheptyl (meth)acrylate, 2-octyl (meth)acrylate, butyl acrylate, and combinations or mixtures thereof. Particularly preferred alkyl (meth)acrylate esters include isooctyl acrylate, 2-ethylhexyl acrylate, 2-octyl acrylate and 2-propylheptyl acrylate.

In an exemplary embodiment, the linear or branched alkyl (meth)acrylate ester is 2-octyl(meth)acrylate. When used in a provided curable precursor composition, 2-octyl (meth)acrylate provides comparable adhesive properties compared with other isomers of octyl (meth)acrylate, such as n-octyl and isooctyl. Advantageously, such curable precursor compositions can have lower inherent and solution viscosities when compared to adhesive compositions derived from other octyl isomers, such as isooctyl acrylate, at the same concentrations, and under the same polymerization conditions.

2-octyl (meth)acrylate may be prepared by conventional techniques from 2-octanol and (meth)acryloyl derivates such as esters, acids and acyl halides. 2-octanol may be prepared by treatment of ricinoleic acid, derived from castor oil, (or ester or acyl halide thereof) with sodium hydroxide, followed by distillation from the co-product sebacic acid.

(Meth)acrylic-based polymers used herein are often prepared from one or more non-polar acrylate monomers with a relatively low glass transition temperature (T_{g}) (i.e., the T_{g} of a monomer is measured as a homopolymer prepared from the monomer) plus various optional monomers such as one or more polar monomers. The polar monomers can have an acidic group, hydroxyl group, or nitrogen-containing group.

Non-polar acrylate monomers in conventional (meth)acrylic-based elastomeric materials include 2-ethylhexyl acrylate (2-EHA) and isooctyl acrylate (IOA).

In some embodiments, the polymer base material further comprises a polar co-monomer. The co-monomer can be, for example, a polar acrylate. Preferred co-monomers include acrylic acid, methacrylic acid, itaconic acid, hydroxyalkyl acrylates, acrylamides and substituted acrylamides, acrylamines and substituted acrylamines, along with combinations and mixtures thereof. Other polar co-monomers include n-substituted acrylamides, acrylonitrile, methacrylonitrile, hydroxyalkyl acrylates, cyanoethyl acrylate, maleic anhydride, n-vinyl-2-pyrrolidone, n-vinyl-caprolactam along with combinations and mixtures thereof.

In exemplary embodiments, the first PSA layer and/or the second PSA layer and/or the third PSA layer for use in the PSA assembly comprises a PSA composition comprising a reaction product of a curable precursor composition comprising:

(a) a linear or branched alkyl (meth)acrylate ester as a main monomer, the main monomer preferably selected from the group consisting of isooctyl (meth)acrylate, 2-ethylhexyl (meth)acrylate, 2-propylheptyl (meth)acrylate, butyl acrylate; and

(b) optionally, a second monomer having an ethylenically unsaturated group, preferably a reinforcing monoethylenically-unsaturated monomers which is copolymerizable with the acrylate main monomer.

In some exemplary aspects, the curable precursor composition used for producing the first PSA layer and/or the second PSA layer and/or the third PSA layer of the PSA assembly comprises at least one second monomer having an ethylenically unsaturated group. Any suitable second monomer having an ethylenically unsaturated group may be used to prepare the curable precursor composition used for producing the first PSA layer and/or the second PSA layer and/or the third PSA layer of the PSA assembly. Suitable second monomer having an ethylenically unsaturated group for use herein will be easily identified by those skilled in the art, in the light of the present description.

Exemplary second monomers having an ethylenically unsaturated group include those selected from the group consisting of polar and non-polar alkyl (meth)acrylate esters, polar monomers, and non-polar vinyl monomers, along with combinations and mixtures thereof.

In an embodiment, the second monomer having an ethylenically unsaturated group comprises an alkyl (meth)acrylate ester, preferably having an alkyl group comprising from 1 to 32 carbon atoms, from 1 to 20 carbon atoms, or from 1 to 15 carbon atoms.

The curable precursor composition can further include a second non-polar monomer having an ethylenically unsaturated group. Any non-polar monomer with an ethylenically unsaturated group can be used as the second monomer to prepare the curable precursor composition used for producing the first PSA layer and/or the second PSA layer and/or the third PSA layer of the PSA assembly. Suitable non-polar monomers having an ethylenically unsaturated group for use herein are known in the art.

Suitable second non-polar monomers having an ethylenically unsaturated group include, but are not limited to, non-polar alkyl (meth)acrylate esters. In particular, the second monomer comprises a non-polar alkyl (meth)acrylate ester having an alkyl group comprising from 1 to 32 carbon atoms, from 1 to 20 carbon atoms, from 1 to 15 carbon atoms, or from 1 to 13 carbon atoms.

Non-polar alkyl (meth)acrylate esters with an alkyl group having from 1 to 30 carbon atoms for use herein include, but are not limited to, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, iso-pentyl (meth)acrylate (i.e., iso-amyl (meth)acrylate), 3-pentyl (meth)acrylate, 2-methyl-1-butyl (meth)acrylate, 3-methyl-1-butyl (meth)acrylate, stearyl (meth)acrylate, phenyl (meth)acrylate, n-hexyl (meth)acrylate, iso-hexyl (meth)acrylate, cyclohexyl (meth)acrylate, 2-methyl-1-pentyl (meth)acrylate, 3-methyl-1-pentyl (meth)acrylate, 4-methyl-2-pentyl (meth)acrylate, 2-ethyl-1-butyl (meth)acrylate, 2-methy-1-hexyl (meth)acrylate, 3,5,5-trimethyl-1-hexyl (meth)acrylate, cyclohexyl (meth)acrylate, 3-heptyl (meth)acrylate, benzyl (meth)acrylate, n-octyl (meth)acrylate, isooctyl (meth)acrylate, 2-octyl (meth)acrylate, 2-ethyl-1-hexyl (meth)acrylate, n-decyl (meth)acrylate, isodecyl (meth)acrylate, isobornyl (meth)acrylate, 2-propylheptyl (meth)acrylate, isononyl (meth)acrylate, isophoryl (meth)acrylate, n-dodecyl (meth)acrylate (i.e., lauryl (meth)acrylate), n-tridecyl (meth)acrylate, iso-tridecyl (meth)acrylate, 3,7-dimethyl-octyl (meth)acrylate, and any combinations or mixtures thereof.

Other suitable alkyl (meth)acrylate esters include those with an alkyl group having at least 14 carbon atoms but that are linear or that have a single branching point. Examples include, but are not limited to, 1-octadecyl (meth)acrylate, 17-methyl-l-heptadecyl (meth)acrylate, and 1-tetradecyl (meth)acrylate.

Still other suitable non-polar (meth)acrylate esters for use herein are aryl (meth)acrylates such as, for example, phenyl (meth)acrylate or benzyl (meth)acrylate; alkenyl (meth)acrylates such as, for example, 3,7-dimethyl-6-octenyl-1 (meth)acrylate and allyl (meth)acrylate; and aryl substituted alkyl (meth)acrylates or aryloxy substituted alkyl (meth)acrylates such as, for example, 2-biphenylhexyl (meth)acrylate, benzyl (meth)acrylate, and 2-phenoxy ethyl (meth)acrylate.

It can be advantageous for the second non-polar monomer in the PSA to have a relatively high T_{g} when formed into a homopolymer (i.e., a polymer prepared using a single type of monomer), as these monomers have the ability to modulate the T_{g} of the curable precursor composition so as to provide enhanced adhesive strength. When formed into a homopolymer, these monomers can have a glass transition temperature (T_{g}) of at least 20° C., or at least 25° C., or at least 30° C., or at least 40° C., or at least 50° C. Alternatively, the second non-polar monomer in the PSA may also have a relatively low T_{g} when formed into a homopolymer—for example, a T_{g} of below 20° C.

Second monomers having an ethylenically unsaturated group for use herein may include a monomer with an acidic group and a single ethylenically unsaturated group (i.e., an acidic monomer). These monomers are typically polar or strongly polar. Polarity (or hydrogen-bonding ability) is frequently described by the use of terms such as ‘strongly’, ‘moderately’, and ‘poorly’. References describing these and other solubility terms include Solvents, Paint Testing Manual, 3rd ed., G. G. Seward, Ed., American Society for Testing and Materials, Philadelphia, Pa., and A Three-Dimensional Approach to Solubility, Journal of Paint Technology, Vol. 38, No. 496, pp. 269-280. The ethylenically unsaturated group can be a (meth)acryloyl group or a vinyl group (i.e., CH₂═CH₂— group) that is not a (meth)acryloyl group. Exemplary acidic monomers can have a carboxylic acid group, sulfonic acid group, phosphonic acid group, or salts thereof. Due to their availability, acidic monomers with carboxylic acid groups or salts thereof are often selected. If stronger acidic groups are desired, monomers with phosphonic acid, sulfonic acid groups, or salts thereof can be used. Examples of acidic monomers include, but are not limited to, (meth)acrylic acid, itaconic acid, fumaric acid, crotonic acid, citraconic acid, maleic acid, oleic acid, beta-carboxyethyl (meth)acrylate, 2-sulfoethyl methacrylate, styrene sulfonic acid, 2-acrylamido-2-methylpropanesulfonic acid, vinylphosphonic acid, or mixtures thereof. Any suitable salt of an acidic group can be used. In many embodiments, the cation of the salt is an ion of an alkaline metal (e.g., sodium, potassium, or lithium ion), an ion of an alkaline earth (e.g., a calcium, magnesium, or strontium ion), an ammonium ion, or an ammonium ion substituted with one or more alkyl or aryl groups.

Strongly polar monomers include acrylic acid, methacrylic acid, itaconic acid, hydroxyalkyl acrylates, acrylamides and substituted acrylamides while, for example n-vinyl pyrrolidone, n-vinyl caprolactam, acrylonitrile, vinylchloride, diallyl phthalate and n,n-dialkylamino (meth)acrylates are typical examples of moderately polar monomers. Further examples for polar monomers include cyano acrylate, fumaric acid, crotonic acid, citronic acid, maleic acid, β-carboxyethyl acrylate or sulfoethyl methacrylate. The alkyl (meth)acrylate monomers enumerated above are typical examples of relatively poorly polar monomers. These examples are given for illustrative reasons only and are not to be understood as limiting. Among the group of polar monomers for use as the second monomer, acrylic acid and n-vinyl caprolactam are particularly preferred.

The curable precursor composition for the PSA layer(s) of the multilayer PSA assembly can comprise up to 10 weight percent of the strongly polar acrylate based on a total weight of curable precursor composition, or from 0.1 to 10 weight percent, from 0.5 to 10 weight percent, from 1.0 to 10 weight percent, from 2.0 to 8.0 weight percent, from 2.5 to 6.0 weight percent, or from 3.0 to 6.0 weight percent when the PSA assembly is intended for adhesion to LSE substrates.

Second monomers having an ethylenically unsaturated group can include those with a single ethylenically unsaturated group and a hydroxyl group. The ethylenically unsaturated group can be a (meth)acryloyl group or a vinyl group (i.e., CH₂═CH₂-group). Exemplary monomers with a hydroxyl group include, but are not limited to, hydroxyalkyl (meth)acrylates (e.g., 2-hydroxyethyl acrylate or 3-hydroxypropyl acrylate), hydroxyalkyl (meth)acrylamides (e.g., 2-hydroxyethyl acrylamide or 3-hydroxypropyl acrylamide), and ethoxylated hydroxyethyl methacrylate (e.g., monomers commercially available from Sartomer, Exton, Pa., under the trade designation CD570, CD571, CD572).

Second monomers having an ethylenically unsaturated group further include those with a single ethylenically unsaturated group and a nitrogen-containing group or a salt thereof. The ethylenically unsaturated group can be a (meth)acryloyl group or a vinyl group (i.e., CH₂═CH₂— group). Examples of nitrogen-containing groups include, but at not limited to, secondary amido groups and tertiary amido groups. Exemplary polar monomers with secondary amido groups include, but are not limited to, n-alkyl (meth)acrylamides such as n-methyl acrylamide, n-ethyl acrylamide, n-isopropyl acrylamide, tert-octyl acrylamide, or n-octyl acrylamide. Exemplary polar monomers with a tertiary amido group include, but are not limited to, n-vinyl caprolactam, n-vinyl-2-pyrrolidone, acryloyl morpholine, and n,n-dialkyl acrylamides such as n,n-dimethyl acrylamide, n,n-diethyl acrylamide, n,n-dipropyl acrylamide, and n,n-dibutyl acrylamide, along with combinations and mixtures thereof.

Polar second monomers having an ethylenically unsaturated group further include those with a single ethylenically unsaturated group and an ether group (i.e., a group containing at least one alkylene-oxy-alkylene group of formula —R—O—R— where each R is an alkylene having 1 to 4 carbon atoms). Exemplary monomers include, but are not limited to, alkoxylated alkyl (meth)acrylates such as ethoxyethoxyethyl acrylate, 2-methoxyethyl acrylate, and 2-ethoxyethyl acrylate; and a poly(alkylene oxide) acrylates such as poly(ethylene oxide) acrylates, and poly(propylene oxide) acrylates. The poly(alkylene oxide) acrylates are sometimes referred to as poly(alkylene glycol) acrylates. These monomers can have any suitable end group such as a hydroxyl group or an alkoxy group. For example, when the end group is a methoxy group, the monomer can be referred to as methoxy poly(ethylene glycol) acrylate.

Polar monomers may be added to increase adhesion of the PSA layer(s) of the PSA assembly to an adjacent layer such as a substrate or a backing layer, to enhance the cohesive strength of the PSA, or both. In some exemplary aspects, the polar monomers are present in amounts up to 15 weight percent based on a total weight of the curable precursor composition used to produce the particular pressure-sensitive adhesive layer of the PSA assembly. In some instances, the polar monomer can be present in an amount in a range of from 0.1 to 15 weight percent, from 0.5 to 15 weight percent, from 1.0 to 10 weight percent, from 2.0 to 8.0 weight percent, from 2.5 to 6.0 weight percent, or from 3.0 to 6.0 weight percent of a first polar monomer. In some other exemplary aspects, this amount is typically up to 10 weight percent or up to 5 weight percent. For example, the polar monomer can be present in an amount in a range of 0 to 15 weight percent, 0.5 to 15 weight percent, 1 to 15 weight percent, 0 to 10 weight percent, 0.5 to 10 weight percent, 1 to 10 weight percent, 0 to 5 weight percent, 0.5 to 5 weight percent, or 1 to 5 weight percent based on a total weight of the curable precursor composition used to produce the particular pressure-sensitive adhesive layer of the PSA assembly.

In some embodiments, the curable precursor composition comprises at least 50 weight percent of a linear or branched alkyl (meth)acrylate ester as a main monomer and up to 15 weight percent, or up to 10 weight percent of a polar monomer, preferably a polar acrylate, based on the total weight of curable precursor composition.

In some embodiments, the curable precursor composition comprises at least 0.1 weight percent, at least 0.5 weight percent, at least 1 weight percent, or at least 2 weight percent, or at least 3 weight percent, of a polar monomer, preferably a polar acrylate, based on the total weight of curable precursor composition.

In some embodiments, the curable precursor composition used to produce the PSA contains: a) from 50 to 99.5 weight percent, or from 60 to 90 weight percent, of a linear or branched alkyl (meth)acrylate ester as its main monomer, wherein the main monomer is preferably selected from the group consisting of isooctyl (meth)acrylate, 2-ethylhexyl (meth)acrylate, 2-propylheptyl (meth)acrylate, butyl acrylate, or a mixture thereof; b) from 0 to 50 weight percent, from 3 to 40 weight percent, from 5 to 35 weight percent, or from 10 to 30 weight percent, of the second monomer having an ethylenically unsaturated group, preferably a second non-polar monomer having an ethylenically unsaturated group; c) from 0 to 15 weight percent, from 0.5 to 15 weight percent, from 1 to 10 weight percent, from 2 to 8 weight percent, from 2 to 6 weight percent, or from 3 to 6 weight percent of a polar monomer, preferably a polar acrylate; and d) optionally, a tackifying resin, where all weight percentages are based on the total weight of curable precursor composition.

In some embodiments, the curable precursor composition used to produce the PSA contains: a) a linear or branched alkyl (meth)acrylate ester as a main monomer, wherein the main monomer is preferably selected from the group consisting of isooctyl (meth)acrylate, 2-ethylhexyl (meth)acrylate, 2-propylheptyl (meth)acrylate, butyl acrylate; b) from 0 to 50 weight percent, from 3 to 40 weight percent, from 5 to 35 weight percent, or from 10 to 30 weight percent, of the second monomer having an ethylenically unsaturated group, preferably a second non-polar monomer having an ethylenically unsaturated group; c) from 0 to 15 weight percent, from 0.5 to 15 weight percent, from 1 to 10 weight percent, from 2 to 8 weight percent, from 2.5 to 6 weight percent, or from 3 to 6 weight percent of a first polar monomer, preferably a polar acrylate; d) optionally, a second polar monomer, preferably a polar non-acrylate monomer; and e) optionally, a tackifying resin; wherein all weight percentages are based on the total weight of curable precursor composition.

Optionally, the curable precursor composition further includes one or more other vinyl monomers such as a vinyl ester (e.g., vinyl acetate and vinyl propionate); styrene or derivative thereof such as alkyl substituted styrene (e.g., □-methyl styrene); vinyl halide; or a mixture thereof. Such monomers can be polar or non-polar. If present, these vinyl monomers can be present in any suitable amount. In some embodiments, the vinyl monomers are present in an amount of up 5 parts by weight, based on a total weight of curable precursor composition. For example, the vinyl monomer can be used in amounts up to 4 weight percent, up to 3 weight percent, or up to 2 weight percent. In some embodiments, the vinyl monomer is present in an amount in a range of 0 to 5 weight percent, 0.5 to 5 weight percent, 1 to 5 weight percent, 0 to 3 weight percent, or 1 to 3 weight percent.

### Tackifiers

The curable precursor composition can further include a tackifier (also called a tackifying resin), typically in an amount from 2 to 30 wt %, from 4 to 20 wt %, or from 6 to 12 wt % of the curable precursor composition.

Optionally, one or more tackifiers, one or more plasticizers, or a mixture thereof can be combined with the curable precursor composition. Tackifiers and plasticizers can be advantageously used to modulate T_{g}, storage modulus, and tackiness of the PSA.

Any tackifiers included in a curable precursor composition are preferably miscible with other components in the curable precursor composition. Any tackifier typically included in conventional PSA compositions may be used. Either solid or liquid tackifiers can be added. Solid tackifiers generally have a weight average molecular weight (or M_{w}) of 10,000 g/mol or less and a softening point above about 70° C. Liquid tackifiers are viscous materials that have a softening point of about 0° C. to about 70° C.

Tackifiers include rosin resins such as rosin acids and their derivatives (e.g., rosin esters); terpene resins such as polyterpenes (e.g., alpha pinene-based resins, beta pinene-based resins, and limonene-based resins) and aromatic-modified polyterpene resins (e.g., phenol modified polyterpene resins); coumarone-indene resins; and petroleum-based hydrocarbon resins such as C5-based hydrocarbon resins, C9-based hydrocarbon resins, C5/C9-based hydrocarbon resins, and dicyclopentadiene-based resins. Tackifying resins, if added, can be hydrogenated to lower their color contribution to the particular pressure-sensitive adhesive composition. Combinations of various tackifiers can be used if desired.

Tackifiers that are rosin esters are the reaction products of various rosin acids and alcohols. These include, but are not limited to, methyl esters of rosin acids, triethylene glycol esters of rosin acids, glycerol esters of rosin acids, and pentaertythritol esters of rosin acids. These rosin esters can be hydrogenated partially or fully to improve stability and reduce their color contribution to the pressure-sensitive adhesive composition. The rosin resin tackifiers are commercially available, for example, from Eastman Chemical Company under the trade designations PERMALYN, STAYBELITE, and FORAL as well as from Newport Industries under the trade designations NUROZ and NUTAC. A fully hydrogenated rosin resin is commercially available, for example, from Eastman Chemical Company under the trade designation FORAL AX-E. A partially hydrogenated rosin resin is commercially available, for example, from Eastman Chemical Company under the trade designation STAYBELITE-E.

Tackifiers based on hydrocarbon resins can be prepared from various petroleum-based feed stocks. These feed stocks can be aliphatic hydrocarbons (mainly C5 monomers with some other monomers present such as a mixture of trans-1,3-pentadiene, cis-1,3-pentadiene, 2-methyl-2-butene, dicyclopentadiene, cyclopentadiene, and cyclopentene), aromatic hydrocarbons (mainly C9 monomers with some other monomers present such as a mixture of vinyl toluenes, dicyclopentadiene, indene, methylstyrene, styrene, and methylindenes), or mixtures thereof. Tackifiers derived from C5 monomers are referred to as C5-based hydrocarbon resins while those derived from C9 monomers are referred to as C9-based hydrocarbon resins. Some tackifiers are derived from a mixture of C5 and C9 monomers or are a blend of C5-based hydrocarbon tackifiers and C9-based hydrocarbon tackifiers. Any of these resins can be partially or fully hydrogenated to improve their color, their thermal stability or their process compatibility.

C5-based hydrocarbon resins are commercially available from Eastman Chemical Company, Kingsport, Tenn., under the trade designations PICCOTAC and EASTOTAC, from Cray Valley, Exton, Pa., under the trade designation WINGTACK, from Neville Chemical Company, Pittsburgh, Pa., under the trade designation NEVTAC LX, and from Kolon Industries, Inc., Gwacheon, South Korea, under the trade designation HIKOREZ. The C5-based hydrocarbon resins are commercially available from Eastman Chemical Company with various degrees of hydrogenation under the trade designation EASTOTACK.

The C9-based hydrocarbon resins are commercially available from Eastman Chemical Company under the trade designation PICCO, KRISTLEX, PLASTOLYN, and PICCOTAC, and ENDEX, from Cray Valley under the trade designations NORSOLENE, from Ruetgers N.V. under the trade designation NOVAREZ, and from Kolon Industries, Inc. under the trade designation HIKOTAC. These resins can be partially or fully hydrogenated. Prior to hydrogenation, the C9-based hydrocarbon resins are often about 40 percent aromatic as measured by proton Nuclear Magnetic Resonance. Hydrogenated C9-based hydrocarbon resins are commercially available, for example, from Eastman Chemical under the trade designations REGALITE and REGALREZ that are 50 to 100 percent (e.g., 50 percent, 70 percent, 90 percent, and 100 percent) hydrogenated. The partially hydrogenated resins typically have some aromatic rings.

Various C5/C9-based hydrocarbon tackifiers are commercially available from Arakawa under the trade designation ARKON, from Zeon under the trade designation QUINTONE, from Exxon Mobile Corp., Irving, Tex., under the trade designation ESCOREZ, and from Newport Industries, Surrey, UK, under the trade designations NURES and H-REZ.

Any of the tackifiers may be used in amounts of up to 30 wt % of the curable precursor composition. The tackifiers can be used in amounts up to 25 wt %, up to 20 wt %, up to 15 wt %, or up to 12 wt %. The amount of tackifier can be for example, in the range of 2 to 30 wt %, in the range of 3 to 25 wt %, in the range of 4 to 20 wt %, in the range of 5 to 15wt %, or in the range of 6 to 12 wt % of the curable precursor composition.

### Plasticizers

Useful curable precursor compositions may include one or more plasticizers. Plasticizers are used to reduce the T_{g} of the composition and are preferably compatible with (i.e., miscible with) other components in the composition such as the curable precursor composition and any optional tackifier. Suitable plasticizers include, but are not limited to, various polyalkylene oxides (e.g., polyethylene oxides or propylene oxides), adipic acid esters, formic acid esters, phosphoric acid esters, benzoic acid esters, phthalic acid esters, and sulfonamides, or naphthenic oils.

### Crosslinkers

The curable precursor composition may further comprise a crosslinker (also referred to as crosslinking agent).

A crosslinker can be considered as a second monomer having an ethylenically unsaturated group. Advantageously, a crosslinker can significantly increase the cohesive strength and the tensile strength of the provided PSA. A crosslinker generally has at least two functional groups which are capable of covalently bonding with the first monomer or another monomer. That is, the crosslinker can have at least two ethylenically unsaturated groups. Suitable crosslinkers often have multiple (meth)acryloyl groups. Alternatively, the crosslinker can have at least two groups that are capable of reacting with various functional groups (i.e., functional groups that are not ethylenically unsaturated groups) on another monomer. For example, the crosslinker can have multiple groups that can react with functional groups such as acidic groups on other monomers.

Crosslinkers with multiple (meth)acryloyl groups include di(meth)acrylates, tri(meth)acrylates, tetra(meth)acrylates, and penta(meth)acrylates. These crosslinkers can be formed, for example, by reacting (meth)acrylic acid with a polyhydric alcohol (i.e., an alcohol having at least two hydroxyl groups). The polyhydric alcohol often has two, three, four, or five hydroxyl groups. Mixtures of crosslinkers may also be used.

Optionally, crosslinkers contain at least two (meth)acryloyl groups. Exemplary crosslinkers with two acryloyl groups include, but are not limited to, 1,2-ethanediol diacrylate, 1,3-propanediol diacrylate, 1,9-nonanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerin tri(meth)acrylate, and neopentylglycol hydroxypivalate diacrylate modified caprolactone.

Crosslinkers with three or four (meth)acryloyl groups include, but are not limited to, trimethylolpropane triacrylate (e.g., commercially available under the trade designation TMPTA-N from Cytec Industries, Inc., Smyrna, Ga. and under the trade designation SR-351 from Sartomer), pentaerythritol triacrylate (e.g., commercially available under the trade designation SR-444 from Sartomer), tris(2-hydroxyethylisocyanurate) triacrylate (e.g., commercially available under the trade designation SR-368 from Sartomer), a mixture of pentaerythritol triacrylate and pentaerythritol tetraacrylate (e.g., commercially available from Cytec Industries, Inc., under the trade designation PETIA with an approximately 1:1 ratio of tetraacrylate to triacrylate and under the trade designation PETA-K with an approximately 3:1 ratio of tetraacrylate to triacrylate), pentaerythritol tetraacrylate (e.g., commercially available under the trade designation SR-295 from Sartomer), di-trimethylolpropane tetraacrylate (e.g., commercially available under the trade designation SR-355 from Sartomer), and ethoxylated pentaerythritol tetraacrylate (e.g., commercially available under the trade designation SR-494 from Sartomer). An exemplary crosslinker with five (meth)acryloyl groups includes, but is not limited to, dipentaerythritol pentaacrylate (e.g., commercially available under the trade designation SR-399 from Sartomer).

In some embodiments, the crosslinker is polymeric and contains at least two (meth)acryloyl groups. For example, the crosslinker can be poly(alkylene oxide) with at least two acryloyl groups (e.g., polyethylene glycol diacrylates commercially available from Sartomer such as SR210, SR252, and SR603) or poly(urethanes) with at least two (meth)acryloyl groups (e.g., polyurethane diacrylates such as CN9018 from Sartomer). As the molecular weight of the crosslinker increases, the resulting acrylic copolymer tends to have a higher elongation before breaking.

Other types of crosslinkers are available. The crosslinker, for example, can have multiple groups that react with functional groups such as acidic groups on other second monomers. Monomers with multiple aziridinyl groups can be used, where such monomers are reactive with carboxyl groups. For example, the crosslinkers can be a bis-amide crosslinker as described in U.S. Pat. No. 6,777,079 (Zhou et al.).

Crosslinking can be actuated or facilitated by actinic radiation, such as ultraviolet or visible light. In these cases, photocrosslinkers (e.g., UV photocrosslinkers) can be added. These photocrosslinkers can be copolymerizable with the various monomers used to form the elastomeric material (e.g., copolymerizable benzophenones) or can be added after polymerization. Suitable photocrosslinkers added after polymerization include, for example, multifunctional benzophenones and triazines (such as XL-330, which is 2,4,-bis(trichloromethyl)-6-(4-methoxyphenyl)-triazine from 3M Company).

In some embodiments, thermal crosslinkers can be used. Optionally thermal crosslinkers can be used in combination with accelerants or retardants. Suitable thermal crosslinkers for use herein include, but are not limited to, isocyanates, more particularly trimerized isocyanates and/or sterically hindered isocyanates that are free of blocking agents, or epoxide compounds such as epoxide-amine crosslinker systems. Advantageous crosslinker systems and methods are described, for example, in European Patent Publication Nos. EP 2305389 (Prenzel et al.), EP 2414143 (Czerwonatis et al.), EP 2192148 (Prenzel et al.), EP 2186869 (Grittner et al.), EP 0752435 (Burmeister et al.), EP1802722 (Zoellner et al.), EP 1791921 (Zoellner et al.), EP 1791922 (Zoellner et al.), and EP 1978069 (Zoellner et al.). Suitable accelerant and retardant systems for use herein are described, for example, in U.S. Pat. No. 9,200,129 (Czerwonatis et al.). Thermal crosslinkers include epoxycyclohexyl derivatives and, in particular, epoxycyclohexyl carboxylate derivatives, with particular preference to (3,4-epoxycyclohexane)methyl 3,4-epoxycyclohexylcarboxylate, commercially available from Cytec Industries Inc. under trade name UVACURE 1500.

If present, a crosslinker can be used in any suitable amount. In some aspects, the crosslinker is present in an amount up to 5 weight percent, up to 4 weight percent, up to 3 weight percent, up to 2 weight percent, or up to 1 weight percent. The crosslinker can be present, for example, in amounts of at least 0.01 weight percent, at least 0.03 weight percent, at least 0.05 weight percent, at least 0.07 weight percent, or at least 0.09 weight percent. In some aspects, the crosslinker is present in an amount in a range of 0 to 5 weight percent, 0.01 to 5 weight percent, 0.05 to 5 weight percent, 0 to 3 weight percent, 0.01 to 3 weight percent, 0.05 to 3 weight percent, 0 to 1 weight percent, 0.01 to 1 weight percent, or 0.05 to 1 weight percent.

Aside from thermal, moisture or photosensitive crosslinking agents, crosslinking may also be achieved using high energy electromagnetic radiation such as gamma or electron beam radiation.

### Initiators

An initiator is typically added to the various monomers used to form the curable precursor composition. The polymerization initiator can be a thermal initiator, a photoinitiator, or both. Any suitable thermal initiator or photoinitiator known for free radical polymerization reactions can be used. The initiator is typically present in an amount in the range of 0.01 to 5 weight percent, in the range of 0.01 to 2 weight percent, in the range of 0.01 to 1 weight percent, or in the range of 0.01 to 0.5 weight percent, based on a total weight of curable precursor composition.

In some executions, a thermal initiator is used. Thermal initiators can be water-soluble or water-insoluble (i.e., oil-soluble) depending on the particular polymerization method used. Suitable water-soluble initiators include, but are not limited to, persulfates such as potassium persulfate, ammonium persulfate, sodium persulfate, and mixtures thereof; an oxidation-reduction initiator such as the reaction product of a persulfate and a reducing agent such as a metabisulfite (e.g., sodium metabisulfite) or a bisulfate (e.g., sodium bisulfate); or 4,4′-azobis(4-cyanopentanoic acid) and its soluble salts (e.g., sodium, potassium). Suitable oil-soluble initiators include, but are not limited to, various azo compounds such as those commercially available under the trade designation VAZO from E. I. DuPont de Nemours Co., Wilmington, Del., including VAZO 67, which is 2,2′-azobis(2-methylbutane nitrile), VAZO 64, which is 2,2′-azobis(isobutyronitrile), and VAZO 52, which is (2,2′-azobis(2,4-dimethylpentanenitrile); and various peroxides such as benzoyl peroxide, cyclohexane peroxide, lauroyl peroxide, and mixtures thereof.

Alternatively, a photoinitiator can be used to cure the curable precursor composition. Exemplary photoinitiators include benzoin ethers (e.g., benzoin methyl ether or benzoin isopropyl ether) or substituted benzoin ethers (e.g., anisoin methyl ether). Other exemplary photoinitiators are substituted acetophenones such as 2,2-diethoxyacetophenone or 2,2-dimethoxy-2-phenylacetophenone (commercially available under the trade designation IRGACURE 651 from BASF Corp. (Ludwigshafen, Germany) or under the trade designation ESACURE KB-1 from Sartomer (Exton, Pa.)). Still other exemplary photoinitiators are substituted alpha-ketols such as 2-methyl-2-hydroxypropiophenone, aromatic sulfonyl chlorides such as 2-naphthalenesulfonyl chloride, and photoactive oximes such as 1-phenyl-1,2-propanedione-2-(O-ethoxycarbonyl)oxime. Other suitable photoinitiators include, for example, 1-hydroxy cyclohexyl phenyl ketone (IRGACURE 184), bis(2,4,6-trimethylbenzoyl)phenylphosphineoxide (IRGACURE 819), 1-[4-(2-hydroxyethoxy)phenyl]-2-hydroxy-2-methyl-1-propane-1-one (IRGACURE 2959), 2-benzyl-2-dimethylamino-1-(4-morpholinophenyl)butanone (IRGACURE 369), 2-methyl-1-[4-(methylthio)phenyl]-2-morpholinopropan-1-one (IRGACURE 907), and 2-hydroxy-2-methyl-1-phenyl propan-1-one (DAROCUR 1173).

### Chain Transfer Agents

Although optional, the curable precursor composition may contain chain transfer agents to control the molecular weight of the resultant elastomeric material. Examples of useful chain transfer agents include, but are not limited to, carbon tetrabromide, alcohols, mercaptans such as isooctylthioglycolate, and mixtures thereof. If used, the polymerizable mixture may include up to 0.5 weight of a chain transfer agent based on a total weight of curable precursor composition. For example, the polymerizable mixture can contain 0.01 to 0.5 weight percent, 0.05 to 0.5 weight percent, or 0.05 to 0.2 weight percent chain transfer agent.

### Other Optional Additives

The provided PSA may further comprise one or more additional fillers other than a hollow, non-porous particulate filler material as described above. Such filler materials may be further added into the curable precursor composition before or after compounding with the hollow, non-porous particulate filler material.

Typical examples of filler material that can be used herein include, but are not limited to, expanded perlite, microspheres, expandable microspheres, ceramic spheres, zeolites, clay fillers, glass beads, hollow inorganic beads, silica type fillers, hydrophobic silica type fillers, hydrophilic silica type fillers, fumed silica, fibers, in particular glass fibers, carbon fibers, graphite fibers, silica fibers, ceramic fibers, electrically and/or thermally conducting particles, and any combinations thereof.

In a particular aspect of the PSA assembly according to the disclosure, the second PSA layer and/or the third PSA layer may further comprise a hollow non-porous particulate filler, wherein the surface of the hollow non-porous particulate filler is preferably provided with a hydrophobic surface modification. Such fillers may be advantageously used to increase the mechanical stability of the PSA assembly and may also increase its shear and peel force resistance.

Fumed silica particles may be advantageously used in combination with the hollow non-porous particulate filler as described above.

As will be apparent to those skilled in the art, other additives may optionally be included in any layer of the PSA assembly to achieve any desired properties. Such additives include pigments, toughening agents, reinforcing agents, fire retardants, antioxidants, and various stabilizers.

### Polymerization Methods

PSA compositions may be prepared by a variety of conventional free radical polymerization methods, including solution, bulk (i.e., with little or no solvent), dispersion, emulsion, and suspension processes. The particular method used can depend on the use of the final PSA article or assembly. The reaction product of the curable precursor compositions may be a random copolymer, block copolymers, or some hybrid architecture.

Based on the polymerization method used, the curable precursor composition may include an organic solvent or may be free or essentially free of an organic solvent. Depending on the context, “essentially free of an organic solvent” can mean that the organic solvent is present in an amount less than 5 weight percent, less than 4 weight percent, less than 3 weight percent, less than 2 weight percent, or less than 1 weight percent based on the weight of the curable precursor composition. If an organic solvent is included in the curable precursor composition, the amount is often selected to provide the desired viscosity. Examples of suitable organic solvents include, but are not limited to, methanol, tetrahydrofuran, ethanol, isopropanol, heptane, acetone, methyl ethyl ketone, methyl acetate, ethyl acetate, toluene, xylene, ethylene glycol alkyl ether, and any combinations or mixtures thereof.

In some methods of preparing the curable precursor composition(s) for the PSA layer(s) of the PSA assembly according to the disclosure, the curable precursor composition containing the monomers is partially polymerized thereby increasing its viscosity to that of a viscous syrup. Generally, the main monomers and other optional monomers are mixed with a portion of the free radical polymerization initiator. Depending on the type of initiator added, the mixture is typically exposed to actinic radiation or heat to partially polymerize the monovalent monomers (i.e., monomers with a single ethylenically unsaturated group). Then, the crosslinker and any remaining portion of the initiator may be added to the syrup-like, partially polymerized material. At this stage, particulate fillers and, optionally, tackifiers and/or plasticizers may also be combined with the partially polymerized material. The resulting mixture can be more readily applied as a coating composition onto a support (e.g., release liner) or another layer (e.g., polymeric foam layer). The coating layer can then be exposed to actinic radiation (when a photoinitator is present) or to heat (when a thermal initiator is present). Exposure to actinic radiation or heat typically results in the further reaction of curable precursor composition within the coating composition.

The provided PSAs can have a storage modulus of less than 300,000 pascals at 25° C. In some embodiments, the storage modulus of the PSA is up to 200,000 pascals, up to 100,000 pascals, up to 50,000 pascals, or up to 25,000 pascals at 25° C. In some embodiments, the storage modulus can be up to 10,000 pascals, up to 9,000 pascals, up to 8,000 pascals, or up to 7,500 pascals at 25° C.

### Manufacturing Methods

The present disclosure is further directed to a method of making a PSA assembly comprising at least one PSA layer, the process comprising the steps of:

a) mixing an alkyl (meth)acrylate, a hollow non-porous particulate filler and a surface-modifying agent comprising a hydrophobic alkoxy silane or hydrophobic organofunctional polysiloxane (or mixture thereof) to provide a curable precursor composition and causing the surface of the hollow non-porous particulate filler to be provided with a hydrophobic surface modification; and

b) curing the curable precursor composition to provide the at least one PSA layer.

According to a particular aspect of this method of making a PSA assembly, a liquid precursor of the first PSA layer is deposited on a substrate and then cured, preferably with actinic radiation, e-beam radiation or by thermal curing.

According to an exemplary aspect of this method, the first PSA layer and a second PSA layer and/or a third PSA layer are prepared separately and subsequently laminated to each other.

According to an alternative exemplary aspect of this method, a liquid precursor of a second PSA layer and/or a third PSA layer is superimposed on the liquid precursor of the first PSA layer before curing, in particular with actinic radiation such as UV, y (gamma) or e-beam radiation or by thermal curing. This method is described in full details in International Patent Publication No. WO 2011/094385 (Kuehneweg et al.).

However, the production of the PSA assembly is not limited to the before mentioned methods. For instance, the PSA assembly may be produced by co-extrusion, solvent-based methods or also combinations thereof.

### Applications

The PSA assembly of the present disclosure can be coated or otherwise applied onto any of a variety of substrates to produce an adhesive-coated article. Potential substrates are not particularly limited. They can be flexible or inflexible and be formed of a polymeric material, glass or ceramic material, metal, or combinations thereof. Suitable polymeric substrates include, but are not limited to, polymeric films such as those prepared from polypropylene, polyethylene, polyvinyl chloride, polyester (polyethylene terephthalate or polyethylene naphthalate), polycarbonate, polymethyl(meth)acrylate, cellulose acetate, cellulose triacetate, and ethyl cellulose. Foam backings may be used. Examples of other substrates include, but are not limited to, metal such as stainless steel, metal or metal oxide coated polymeric material, metal or metal oxide coated glass, and the like.

The PSA assemblies of the present disclosure may be used in any article conventionally known to use such assemblies such as labels, tapes, signs, covers, marking indices, display components, touch panels, and the like. Flexible backing materials having microreplicated surfaces are also contemplated.

The PSA assembly may be coated/applied on a substrate using any conventional coating techniques modified as appropriate to the particular substrate. For example, PSA assemblies may be applied/coated to a variety of solid substrates by methods such as roller coating, flow coating, dip coating, spin coating, spray coating knife coating, and die coating. These various methods of coating allow the PSA assemblies to be placed on the substrate at variable thicknesses thus allowing a wider range of use of the assemblies.

The provided PSA assemblies can form strong adhesive bonds to low surface energy (LSE) substrates. Such substrates include polypropylene, polyethylene (e.g., high density polyethylene or HDPE), blends of polypropylene (e.g. PP/EPDM, TPO). Other substrates may also have properties of low surface energy due to a residue, such as an oil residue or a film, such as paint, being disposed on the surface of a different substrate.

Use of the provided PSAs is not limited to low surface energy substrates. The PSA assemblies can bond well to medium surface energy (MSE) substrates such as, for example, polyamide 6 (PA6), ABS, PC/ABS blends, PC, PVC, PA, PUR, TPE, POM, polystyrene, poly(methyl methacrylate), clear coat surfaces, in particular clear coats for vehicles like a car or coated surfaces for industrial applications and composite materials like fiber reinforced plastics.

The provided PSA assemblies can also provide a strong adhesive bond to higher surface energy (HSE) substrates such as, for example, ceramics, glasses, and metals.

Accordingly, the present disclosure is further directed to the use of a PSA assembly as above described for the bonding to a low surface energy substrate, a medium surface energy substrate and/or a high surface energy substrate.

The substrate to which the PSA assembly may be applied generally depends on the application at hand. For example, the PSA assembly, in particular via its second and/or third PSA layer may be applied to sheeting products (e.g., decorative graphics and reflective products), label stock, and tape backings. Additionally, the PSA assembly may be applied directly onto other substrates such as a metal panel (e.g., automotive panel) or a glass window so that yet another substrate or object can be attached to the panel or window. Accordingly, the PSA assembly of the present disclosure may find a particular use in the automotive manufacturing industry (e.g. for attachment of exterior trim parts or for weatherstrips), in the construction industry or in the solar panel construction industry.

Accordingly, the present disclosure is further directed to the use of a PSA assembly as above described for industrial applications, in particular as acrylic foam tapes used in construction and automotive applications.

The PSA assembly may also be provided in the form of a PSA transfer tape in which at least one layer of the PSA assembly is disposed on a release liner for application to a permanent substrate at some later time. The PSA assembly may also be provided as a single coated or double coated tape in which the PSA assembly is permanently disposed on a backing. Backings can be made from plastics (e.g., polypropylene, including biaxially oriented polypropylene, vinyl, polyethylene, polyester such as polyethylene terephthalate), nonwovens (e.g., papers, cloths, nonwoven scrims), metal foils, and foams (e.g., polyacrylic, polyethylene, polyurethane, neoprene). Polymeric foams are commercially available from various suppliers such as 3M Company, Voltek, and Sekisui. The polymeric foam layer may be formed as a coextruded sheet with the PSA assembly on one or both sides of the polymeric foam layer, or the PSA assembly may be laminated to it.

When the PSA assembly is laminated to the substrate, it may be desirable to treat the surface of the substrate to improve the adhesion. Such treatments are typically selected based on the nature of the materials in the PSA assembly and of the substrate and include primers and surface modifications (e.g., corona treatment and surface abrasion).

For a single-sided tape, the PSA assembly is applied to one surface of the backing material and a suitable release material is applied to the opposite surface of the backing material. Release materials are known and include materials such as, for example, silicones, polyolefins, polycarbamates, and polyacrylics. For double coated tapes, the PSA assembly is applied to one surface of the backing material and a PSA assembly is disposed on the opposite surface of the backing material. Double coated tapes are often carried on a release liner.

Not intended to be exhaustive, further non-limiting embodiments are enumerated as follows:
1. A curable precursor composition for a pressure-sensitive adhesive comprising: an alkyl (meth)acrylate; a hollow non-porous particulate filler; and a surface-modifying agent comprising a hydrophobic alkoxy silane or hydrophobic organofunctional polysiloxane.
2. The curable precursor composition of embodiment 1, wherein the hollow non-porous particulate filler consists of hollow glass microspheres.
3. The curable precursor composition of embodiment 1 or 2, wherein the surface-modifying agent has the following chemical structure:

(R¹-O)ₘ(R²)ₚSi—[(O—Si(OR¹)_{q}(R²)₂₋₂)ₓ−Si(O—R¹)ₘ(R²)₃₋ₘ]ᵣ

,wherein R¹ is independently an alkyl, R² is independently a hydrophobic moiety, m is in a range of from 0 to 3, p is in a range of from 0 to 3, q is in a range of from 0 to 2, r is in a range of from 0 to 4, x is in a range of from 0 to 9, wherein the sum m+p+r equals 4 and wherein at least one R¹ and at least one R² are present.
4. The curable precursor composition of embodiment 3, wherein R¹ has from 1 to 6 carbon atoms.
5. The curable precursor composition of embodiment 4, wherein R¹ has from 1 to 4 carbon atoms.
6. The curable precursor composition of embodiment 5, wherein R¹ has 1 or 2 carbon atoms.
7. The curable precursor composition of any one of embodiments 3-6, wherein the hydrophobic moiety R² is selected from the group consisting of: saturated, unsaturated, linear, branched, and cyclic alkyls, and combinations thereof.
8. The curable precursor composition of embodiment 7, wherein the hydrophobic moiety has from 1 to 100 carbon atoms.
9. The curable precursor composition of embodiment 8, wherein the hydrophobic moiety has from 1 to 50 carbon atoms.
10. The curable precursor composition of embodiment 9, wherein the hydrophobic moiety has from 1 to 30 carbon atoms.
11. The curable precursor composition of embodiment 10, wherein the hydrophobic moiety has from 1 to 25 carbon atoms.
12. The curable precursor composition of any one of embodiments 3-11, wherein R² is independently selected from the group consisting of: methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, fluorinated derivatives thereof, and tridecafluroro-1,2,2,2-tetrahydrooctyl.
13. The curable precursor composition of embodiment 12, wherein R² is independently selected from the group consisting of: methyl, propyl, n-octyl, and hexadecyl.
14. A pressure-sensitive adhesive composition obtained by curing the curable precursor composition of any one of embodiments 1 to 13.
15. A pressure-sensitive adhesive assembly comprising: a backing layer; and a first pressure-sensitive adhesive layer comprising the pressure-sensitive adhesive composition of embodiment 14 disposed on the backing layer.
16. The pressure-sensitive adhesive assembly of embodiment 15, wherein the first pressure-sensitive adhesive layer is a polymeric foam layer.
17. The pressure-sensitive adhesive assembly according to embodiment 15 or 16, further comprising a second pressure-sensitive adhesive layer disposed on one or both major surfaces of the first pressure-sensitive adhesive layer.
18. The pressure-sensitive adhesive assembly of embodiment 17, which is in the form of a skin/core multilayer pressure-sensitive adhesive assembly wherein the first pressure-sensitive adhesive layer is the core layer of the multilayer pressure-sensitive adhesive assembly and the second pressure-sensitive adhesive layer is the skin layer of the multilayer pressure-sensitive adhesive assembly.
19. The pressure-sensitive adhesive assembly of any of embodiments 15 to 18, wherein the second pressure-sensitive adhesive layer comprises a polymer base material selected from the group consisting of polyacrylates, polyurethanes, polyolefins, polyamines, polyamides, polyesters, polyethers, polyisobutylene, polystyrenes, polyvinyls, polyvinylpyrrolidone, natural rubbers, synthetic rubbers, and copolymers and blends thereof.
20. The pressure-sensitive adhesive assembly of embodiment 19, wherein the second pressure-sensitive adhesive layer comprises a polyacrylate whose main monomer component comprises a linear or branched alkyl (meth)acrylate ester.
21. The pressure-sensitive adhesive assembly of embodiment 20, wherein the second pressure-sensitive adhesive layer comprises a non-polar linear or branched alkyl (meth)acrylate ester having a linear or branched alkyl group.
22. The pressure-sensitive adhesive assembly of embodiment 21, wherein the linear or branched alkyl group has from 1 to 32 carbon atoms.
23. The pressure-sensitive adhesive assembly of embodiment 22, wherein the linear or branched alkyl group has from 4 to 20 carbon atoms.
24. The pressure-sensitive adhesive assembly of embodiment 23, wherein the linear or branched alkyl group has from 4 to 12 carbon atoms.
25. A method of making a pressure-sensitive adhesive comprising: mixing an alkyl (meth)acrylate, hollow non-porous particulate filler, and a surface-modifying agent comprising a hydrophobic alkoxy silane or hydrophobic organofunctional polysiloxane to provide a curable precursor composition; and curing the curable precursor composition to provide the pressure-sensitive adhesive.
26. The method of embodiment 25, wherein the surface-modifying agent is present in an amount of from 0.05 weight percent to 3 weight percent, based on the overall weight of the precursor composition.

27. The method of embodiment 26, wherein the surface-modifying agent is present in an amount of from 0.1 weight percent to 2 weight percent, based on the overall weight of the precursor composition.
28. The method of embodiment 27, wherein the surface-modifying agent is present in an amount of from 0.3 weight percent to 1.5 weight percent, based on the overall weight of the precursor composition.
29. The method of any one of embodiments 25-28, wherein the hollow, non-porous particulate filler is present in an amount of from 6 weight percent to 14 weight percent, based on the overall weight of the curable precursor composition.
30. The method of embodiment 29, wherein the hollow, non-porous particulate filler is present in an amount of from 8 weight percent to 13 weight percent, based on the overall weight of the curable precursor composition.
31. The method of embodiment 30, wherein the hollow, non-porous particulate filler is present in an amount of from 10 weight percent to 12 weight percent, based on the overall weight of the curable precursor composition.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials

| Designation | Description | Source |
|---|---|---|
| AA | Acrylic acid | Dow Chemical Company, |
| | | Midland, MI |
| EHA | 2-Ethylhexyl acrylate | BASF, Florham Park, NJ |
| HDDA | Hexanediol diacrylate | Cytec Industries, Smyrna, |
| | | GA |
| IBOA | Isobornyl acrylate | San Esters Corp., New |
| | | York, NY |
| IOA | Isooctyl acrylate | 3M Company, St. Paul, MN |
| AEROSIL R972 | A hydrophobic fumed silica, available under the | Evonik, Parsippany, NJ |
| | trade designation “AEROSIL R972” | |
| DS-9116 | Hexadecyltrimethoxysilane, available under the | Evonik, Parsippany, NJ |
| | trade designation “DYNASYLAN 9116” | |
| DS-9896 | An oligomeric, short-chain, alkyl-functionalized | Evonik, Parsippany, NJ |
| | alkoxysilane, available under the trade designation | |
| | “DYNASYLAN 9896” | |
| DS-OCTMO | Octyltrimethoxysilane, available under the trade | Evonik, Parsippany, NJ |
| | designation “DYNASYLAN OCTMO” | |
| IRG651 | 2,2-dimethoxy-1,2-diphenylethan-1-one, available | BASF, Florham Park, NJ |
| | under the trade designation “IRGACURE 651 | |
| K15 | Glass bubbles, non-treated | 3M Company, St. Paul, MN |
| sK15 | hexadecyltrimethoxysilane treated glass bubbles, | Hoffmann Mineral GmbH, |
| | Lot 84352 | Neuburg (Dorau), Germany |
| P-125 | A hydrogenated C9 tackifier, available under the | Arakawa Chemical (USA), |
| | trade designation “ARKON P-125” | Inc., Chicago, IL |
| PENN PIGMENT | Carbon black dispersed in 2-phenoxyethyl acrylate | Penn Color, Inc., |
| | (18 wt % solids), available under the trade | Doylestown, PA |
| | designation “PENNCO 9B117” | |

### Test Methods

### Tape Adhesion Performance (“90° Peel Test”)

Substrates were cleaned with SURPASS facial tissues (Kimberly-Clark) wetted with aqueous isopropyl alcohol (50:50 vol/vol) then allowed to dry. Tape strips (1 inch×4 inches, ˜2.5 cm x×˜10 cm) were cut from each pressure-sensitive adhesive assembly, were backed on one face with anodized aluminum foil and the other face was placed onto the primed surface, then pressed down twice under a 15 pound (6.8 kg) roller moving at 12 inches (˜30 cm) per minute. 90° peel strengths were assessed after standing 72 hours at room temperature, pulling the anodized aluminum foil backing perpendicular to the substrate at 12 inches (˜30 cm) per minute. The average peel force was recorded along with failure mode. Failure mode “fs” indicates cohesive failure within the foam tape during testing, “cp” means the tape peeled cleanly from the surface and the tape did not fail cohesively during testing, and “mix” indicates a mixture of fs and cp failure modes were observed during testing. A list of adhesion performance test substrates immediately follows:

### Adhesion Performance Test Substrates

| Designation | Description | Source |
|---|---|---|
| stainless steel | Polished stainless steel | ChemInstruments, |
| | | Fairfield, OH |
| clear acrylic | Acrylic Clear, Ext PE Mask, 0.118″ thick | Plastics International, |
| | | Eden Prairie, MN |
| polycarbonate | MAKROLON GP, clear, 0.118″ thick | Plastics International |
| NYLON | Nylon Type 6/6 Natural, 0.125″ thick | Plastics International |
| Rigid PVC | Type 1 Grade 1 Gray PVC, 0.125″ thick | Plastics International |
| polyester FRP | GPO-3 Polyester/Glass red, 0.125″ thick, glass fiber | Plastics International |
| | reinforced polyester | |
| Epoxy FRP | FR4 Epoxy/Glass, 0.125″ thick, glass fiber reinforced | Plastics International |
| | thermoset epoxy resin | |
| phenolic | CE Phenolic/Canvas Natural, 0.125″ thick, canvas | Plastics International |
| | reinforced phenolic | |
| TPO | BASEL HIFAX ETA 3131 BLK thermoplastic polyolefin | Standard Plaque, |
| | | Melvindale, MI |
| polypropylene | Polypropylene SR Natural, 0.125″ thick | Plastics International |
| DURACOAT | DC105W-2196 19G1393 POLAR WHITE, roll-coated, | Dura Coat Products, |
| 85G | heat-cured, wax-containing coating (0.75 mil thick) on | Huntsville, AL |
| | 0.019″ thick aluminum | |

### Tape Holding Power (“Static Shear Test”)

Stainless steel panels were cleaned five times with SURPASS facial tissues (Kimberly-Clark) wetted with solvent; first with ethyl acetate, then with aqueous isopropyl alcohol (50:50 vol/vol), and then three times with acetone; then allowed to dry. Tape strips (0.5 inch×1 inches, ˜1.3 cm ×˜2.5 cm) were cut from each pressure-sensitive adhesive assembly, mounted between two flat, polished stainless steel panels, pressed 15 minutes under 1 kg masses, the assembly was suspended from one stainless steel panel in a 158° F. (70° C.) oven, allowed to equilibrate 10 minutes, then a 500 g mass was attached to the other panel and the timer started. Time to failure and failure mode was recorded. Bonds still surviving after 10,000 minutes were taken down intact and denoted >10,000 minutes.

### Preparative Example 1

### (PE-1) Premix for Preparation of Curable Precursor Compositions

An IOA/AA partially polymerized syrup was prepared by mixing 96 parts IOA, 4 parts AA, and 0.04 parts IRG651; inerting the mixture and headspace with nitrogen; stirring the mixture and irradiating at 0.3 mW/cm² until reaching about 2500 cps viscosity; then quenching with air purge. A 50 wt % solution of P-125 in EHA was prepared separately by dissolving P-125 in an equal weight of EHA. A 10 wt % solution of HDDA in EHA was prepared separately by diluting one part HDDA in nine parts EHA. The ingredients listed in Table 2 were combined and mixed gently until homogeneous. PE-1 comprises 0.08 phr HDDA, 0.20 phr IRG651, and 12.5 phr P-125. The term “phr” refers to the total “parts per hundred weight of IOA+EHA+AA”; in this case, IOA+EHA+AA is the sum of weights of IOA/AA syrup, EHA, AA, 0.5*P-125 solution weight, and 0.9*HDDA solution.

TABLE 2
Ingredients for PE-1.

| Ingredient | Amount, grams |
|---|---|
| IOA/AA syrup | 156.48 |
| EHA | 29.30 |
| AA | 2.34 |
| HDDA (10 wt % in EHA) | 1.72 |
| IRG651 | 0.43 |
| P-125 (50 wt % in EHA) | 53.75 |
| PENN PIGMENT | 0.43 |

### Preparative Example 2

### (PE-2): Premix for Preparation of Curable Precursor Compositions

PE-2 was prepared according to PE-1, except the first three ingredients (IOA/AA syrup, EHA, AA) were replaced with an equal weight (188.12 grams) of IOA/EHA/AA partially polymerized syrup. The partially polymerized IOA/EHA/AA syrup was prepared by mixing 79.8 parts IOA, 15.6 parts EHA, 4.6 parts AA, and 0.04 parts IRG651; rendering inert the mixture and headspace with nitrogen; stirring the mixture and irradiating at 0.3 mW/cm² until reaching about 2500 cps viscosity; then quenching with air purge.

### Preparative Example 3

### (PE-3) for Preparation of Pressure-Sensitive Adhesive Skins

High T_{g} Acrylic Copolymer was prepared according to US 2014/0044457 Preparation of High T_{g} Copolymers HTG1. Low T_{g} Acrylic Syrup was prepared according to the method of US 2014/0044457 Preparation of Low T_{g} Acrylic Syrups (S 1-S5), but using 83.75 parts EHA, 3.75 parts AA, and 12.50 parts IBOA. PE-3 pressure-sensitive adhesive skins were prepared according to US 2015/0044457 Examples 6, except replacing P140 with P-125 and using High T_{g} Acrylic Copolymer above, Low T_{g} Acrylic Syrup above, and P-125 in the ratios shown in Table 3.

TABLE 3
Ingredients for PE-3

| Ingredient | Weight fraction |
|---|---|
| High T_{g} Acrylic Copolymer | 0.18 |
| Low T_{g} Acrylic Syrup | 0.71 |
| P-125 | 0.11 |

### Example 1

### (EX-1): Curable Precursor Composition Including an Oligosiloxane Modifier

The amounts of ingredients were as summarized in Table 4. Accordingly, to a 56.85 gram portion of PE-1 was added 5.0 grams of AEROSIL R972 and 0.70 gram of DS-9896, and this mixture was stirred aggressively with a saw toothed blade for three minutes until warm (about 43° C.) and homogeneous, and then 8.00 grams of K15 glass bubbles were added with gentle mixing.

TABLE 4

| | | | AEROSIL | Glass bubbles |
|---|---|---|---|---|
| | PE-1, | Modifier, | R972 | (16 phr, |
| Example | grams | 1 wt % | (10 phr) | 8.00 grams) |
| EX-1 | 56.85 | DS-9896 | 5.0 grams | K15 |
| | | (0.70 gram) | | |
| CE-1 | 56.85 | none | 5.0 grams | sK15 |
| CE-2 | 56.85 | none | 5.0 grams | K15 |

### Comparative Examples 1 (CE-1)

The amounts of ingredients were as summarized in Table 4. For CE-1, 5.0 g of AEROSIL R972 was added to 56.85 grams of PE-1, and this mixture was stirred aggressively with a saw toothed blade for three minutes until warm (about 43° C.) and homogeneous, and then 8.00 grams of silanized sK15 glass bubbles were added with gentle mixing.

### Comparative Example 2 (CE-2)

The procedure was the same as for CE-1, except that K15 glass bubbles were used instead of sK15 silanized glass bubbles, as summarized in Table 4.

### Example 2 (EX-2)

### Cured Composition Including K15 Glass Bubbles and an Oligosiloxane Modifier

The resulting mixture from EX-1 was slowly tumbled overnight and then was cast between silicone-coated poly(ethylene terephthalate) (PET) release liner films at a 43 mil (˜1.1 mm) thickness. The cast mixture was then irradiated with UV light for 190 seconds at 1.5 mW/cm², followed by 230 seconds at 8.0 W/cm². The resulting cured core was then laminated on both sides (after removal of the PET release liners) to PE-3 pressure-sensitive adhesive skins (prepared on PET release liners). The 90° Peel Test results were as summarized in Table 5. The Static Shear Test results were as summarized in Table 6.

### Comparative Examples 3 (CE-3)

### Cured Composition Including sK15 Glass Bubbles, No Modifier

The resulting mixture from CE-1 was treated according to the process for EX-1. The 90° Peel Test results were as summarized in Table 5.

### Comparative Example 4 (CE-4)

### Cured Composition Including K15 Glass Bubbles, No Modifier

The resulting mixture from CE-2 was treated according to the process for EX-1. The 90° Peel Test results (averages of three runs) were as summarized in Table 5.

TABLE 5

| | 90° Peel Test and failure mode | | | | | |
|---|---|---|---|---|---|---|
| | Stainless steel | | Clear acrylic | | DURACOAT 85G | |
| | piw | | piw | | piw | |
| Example | (N/cm) | mode | (N/cm) | mode | (N/cm) | mode |
| EX-2 | 38.3 | mix | 38.3 | fs | 19.7 | cp |
| | (66.6) | | (66.6) | | (34.3) | |
| CE-3 | 34.7 | fs | 35.2 | fs | 21.1 | cp |
| | (60.4) | | (61.2) | | (36.7) | |
| CE-4 | 33.3 | cp | 39.5 | fs | 19.6 | cp |
| | (57.9) | | (68.7) | | (34.1) | |

TABLE 6

| | | Static shear on stainless steel | |
|---|---|---|---|
| | | 500 g@158° F. (70° C.) | |
| Example | Run | minutes | mode |
| EX-2 | 1 | 2075 | 2B |
| | 2 | >10,000 | Td |
| | 3 | >10,000 | Td |

The 90° Peel Test of EX-2 was assessed on additional substrates, with results as summarized in Table 7.

TABLE 7
90° Peel Test and failure mode for EX-2 on additional substrates

| | 90 Peel Test | |
|---|---|---|
| | and failure mode | |
| | (average of 2 runs) | |
| Substrate | piw (N/cm) | mode |
| polycarbonate | 38.6 (67.2) | fs |
| NYLON | 38.7 (67.3) | fs |
| Rigid PVC | 37.5 (65.2) | fs |
| Polyester FRP | 36.0 (62.6) | fs |
| Epoxy FRP | 38.6 (67.2) | fs |
| phenolic | 22.4 (39.0) | cp |
| TPO | 36.7 (63.9) | mix |
| Polypropylene | 9.3 (16) | cp |

### Examples 3 to 5 (EX-3 to EX-5)

### Curable Precursor Compositions Including an Oligosiloxane Modifier

For each of EX-3 to EX-5, the procedure for EX-1 was followed, except using PE-2 as the pre-mix and also varying the amount of DS-9896, according to the relative amounts of materials listed in Table 8.

TABLE 8

| | | Amount of | AEROSIL, | K15 glass |
|---|---|---|---|---|
| | | DS-9896, | R972, | bubbles, |
| Example | Pre-mix | wt % | phr | phr |
| EX-3 | PE-2 | 0.5 | 10 | 16 |
| EX-4 | PE-2 | 1 | 10 | 16 |
| EX-5 | PE-2 | 2 | 10 | 16 |

### Examples 6 to 8 (EX-6 to EX-8)

For each of EX-3 to EX-5, the procedure of EX-2 was followed, to give cured, laminated samples EX-6 to EX-8 having PSA skins. Thus, EX-6 resulted from EX-3, EX-7 resulted from EX-4, and EX-8 resulted from EX-5. The 90° Peel Test results were as summarized in Table 9. The Static Shear Test results were as summarized in Table 10.

TABLE 9

| | 90° Peel Test and failure mode | | | | | |
|---|---|---|---|---|---|---|
| | Stainless Steel | | Clear Acrylic | | DURACOAT 85G | |
| | piw | | piw | | piw | |
| Example | (N/dm) | mode | (N/dm) | mode | (N/dm) | mode |
| EX-6 | 29 | mix | 38.4 | fs | 19.9 | cp |
| (from EX-3) | (50.4) | | (66.8) | | (34.6) | |
| EX-7 | 33.3 | mix | 38.4 | fs | 18.9 | cp |
| (from EX-4) | (57.9) | | (66.8) | | (32.8) | |
| EX-8 | 32.6 | mix | 35.8 | mix | 20.3 | cp |
| (from EX-5) | (56.7) | | (62.2) | | (35.3) | |

TABLE 10
Static Shear Test results for EX-6 to EX-8 (Stainless Steel)

| | | 500 g@158° F. (70° C.) | |
|---|---|---|---|
| Example | Run | minutes | minutes |
| EX-6 (from EX-3) | 1 | >10,000 | td |
| | 2 | >10,000 | td |
| | 3 | >10,000 | td |
| EX-7 (from EX-4) | 1 | >10,000 | td |
| | 2 | >10,000 | td |
| | 3 | 3630 | 2B |
| EX-8 (from EX-5) | 1 | >10,000 | td |
| | 2 | >10,000 | td |
| | 3 | >10,000 | td |

### Example 9 (EX-9)

EX-7 was repeated (starting with the curable precursor composition of EX-4), except replacing the PE-3 pressure-sensitive adhesive skins with skins having an identical adhesive but prepared on silicone-treated polyethylene-coated Kraft paper (PCK) liner in place of silicone-treated polyester liner.

TABLE 11

| | | 90° Peel Test and failure mode | | | | | | | |
|---|---|---|---|---|---|---|---|---|---|
| | | | | | | DURACOAT | | Static shear, | |
| | | Stainless Steel | | Clear Acrylic | | 85G | | Stainless Steel | |
| | | piw | | piw | | piw | | 500 g @ 158° F. | |
| Example | Run | (N/dm) | mode | (N/dm) | mode | (N/dm) | mode | minutes | mode |
| EX-9 | 1 | 38.2 | fs | 36.9 | fs | 22.3 | cp | 5351 | po |
| | | (66.4) | | (64.2) | | (38.8) | | | |
| | 2 | 37.9 | cp | 24.1 | cp | 19.7 | cp | >10,000 | td |
| | | (65.9) | | (41.9) | | (34.2) | | | |
| | 3 | 35.5 | cp | 37.8 | fs | 19.8 | cp | >10,000 | td |
| | | (61.7) | | (65.7) | | (34.4) | | | |
| | Avg | 37.2 | mix | 33.0 | mix | 20.6 | cp | — | — |
| | | (64.7) | | (57.4) | | (35.8) | | | |

### Examples 10 to 14 (EX-10 to EX-14)

### Curable Precursor Compositions Including Silanes

Additional examples of curable precursor compositions were prepared, following the procedure used in EX-1, except using the pre-mix PE-2 in place of PE-1, and using the silanes DS-OCTMO or DS-9116 in place of DS-9896. Amounts are summarized in Table 12.

TABLE 12

| | | | Amount | AEROSIL | K15 glass |
|---|---|---|---|---|---|
| | | | of silane, | R972, | bubbles, |
| Example | Pre-mix | Silane | wt % | phr | phr |
| EX-10 | PE-2 | DS-OCTMO | 0.1 | 10 | 16 |
| EX-11 | PE-2 | DS-OCTMO | 0.24 | 10 | 16 |
| EX-12 | PE-2 | DS-OCTMO | 1 | 10 | 16 |
| EX-13 | PE-2 | DS-9116 | 0.38 | 10 | 16 |
| EX-14 | PE-2 | DS-9116 | 1 | 10 | 16 |

### Examples 15 to 19 (EX-15 to EX-19)

For each of EX-10 to EX-14, the procedure of EX-2 was followed, to give cured, laminated samples EX-15 to EX-19 having PSA skins. Thus, EX-15 resulted from EX-10, EX-16 resulted from EX-11, EX-17 resulted from EX-12, EX-18 resulted from EX-13, and EX-19 resulted from EX-14. The 90° Peel Test results were as summarized in Table 13. The Shear Test results were as summarized in Table 14.

TABLE 13

| | 90° Peel Test and failure mode | | | | | |
|---|---|---|---|---|---|---|
| | Stainless Steel | | Clear Acrylic | | DURACOAT 85G | |
| | piw | | piw | | piw | |
| Example | (N/cm) | mode | (N/cm) | mode | (N/cm) | mode |
| EX-15 | 29.4 | cp | 35.6 | mix | 20.5 | cp |
| | (51.1) | | (61.9) | | (35.6) | |
| EX-16 | 27 | cp | 34.6 | mix | 20.3 | cp |
| | (46.9) | | (60.2) | | (35.3) | |
| EX-17 | 31.7 | mix | 31.6 | fs | 23.9 | cp |
| | (55.1) | | (54.9) | | (41.5) | |
| EX-18 | 29 | mix | 32.2 | fs | 21.8 | cp |
| | (50.4) | | (56.0) | | (37.9) | |
| EX-19 | 31.7 | fs | 31.3 | fs | 28.7 | mix |
| | (55.1) | | (54.4) | | (49.9) | |

TABLE 14

| | | Static shear, Stainless Steel | |
|---|---|---|---|
| Example | Run | 500 g@158° F. (70° C.) | |
| EX-15 | 1 | >10,000 | td |
| | 2 | 8438 | po |
| | 3 | 2584 | po |
| EX-16 | 1 | >10,000 | td |
| | 2 | 3836 | po |
| | 3 | >10,000 | td |
| EX-17 | 1 | >10,000 | td |
| | 2 | 2441 | 2B |
| | 3 | 1862 | 2B |
| EX-18 | 1 | >10,000 | td |
| | 2 | >10,000 | td |
| | 3 | 1154 | po |
| EX-19 | 1 | >10,000 | td |
| | 2 | 1017 | po |
| | 3 | 3940 | 2B |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A pressure-sensitive adhesive assembly, comprising:
a backing layer; and
a first cured pressure-sensitive adhesive composition, comprising:
an alkyl (meth)acrylate;
a hollow non-porous particulate filler; and
a surface-modifying agent comprising a hydrophobic alkoxy silane or hydrophobic organofunctional polysiloxane,
wherein the first pressure-sensitive adhesive layer is disposed on the backing layer, and wherein the first pressure-sensitive adhesive layer is a polymeric foam layer.

2. The pressure-sensitive adhesive assembly of claim 1, wherein the hollow non-porous particulate filler consists of hollow glass microspheres.

3. The pressure-sensitive adhesive assembly of claim 1, wherein the surface-modifying agent has the following chemical structure:
(R¹-O)ₘ(R²)ₚSi—[(O—Si(OR¹)_{q}(R²)_{2-q})ₓ—Si(O—R¹)ₘ(R²)₃₋ₘ]ᵣ
wherein R¹ is independently an alkyl, R² is independently a hydrophobic moiety, m is in a range of from 0 to 3, p is in a range of from 0 to 3, q is in a range of from 0 to 2, r is in a range of from 0 to 4, x is in a range of from 0 to 9, wherein the sum m+p+r equals 4 and wherein at least one R¹ and at least one R² are present.

4. The pressure-sensitive adhesive assembly of claim 3, wherein R¹ has from 1 to 4 carbon atoms.

5. The pressure-sensitive adhesive assembly of claim 4, wherein R¹ has 1 or 2 carbon atoms.

6. The pressure-sensitive adhesive assembly of claim 3, wherein the hydrophobic moiety has from 1 to 25 carbon atoms.

7. The pressure-sensitive adhesive assembly of claim 3, wherein R² is independently selected from the group consisting of: methyl, propyl, n-octyl, and hexadecyl.

8. The pressure-sensitive adhesive assembly according to claim 1, further comprising a second pressure-sensitive adhesive layer disposed on one or both major surfaces of the first pressure-sensitive adhesive layer.

9. The pressure-sensitive adhesive assembly of claim 8 which is in the form of a skin/core multilayer pressure-sensitive adhesive assembly, wherein the first pressure-sensitive adhesive layer is the core layer of the multilayer pressure-sensitive adhesive assembly and the second pressure-sensitive adhesive layer is the skin layer of the multilayer pressure-sensitive adhesive assembly.

10. The pressure-sensitive adhesive assembly of claim 9, wherein the second pressure-sensitive adhesive layer comprises a polyacrylate whose main monomer component comprises a linear or branched alkyl (meth)acrylate ester having a linear or branched alkyl group.

11. The pressure-sensitive adhesive assembly of claim 10, wherein the linear or branched alkyl group has from 4 to 12 carbon atoms.
